(19) United States
(12) Patent Application Publication
(10) Pub. No.: US 2022/0415122 A1
(43) Pub. Date: Dec. 29, 2022

(54) METHODS, APPARATUSES, SYSTEMS, DEVICES AND STORAGE MEDIA FOR PROCESSING ABNORMAL EVENT

(71) Applicant: SENSETIME INTERNATIONAL PTE. LTD., Singapore (SG)

(72) Inventors: Xinxin Wang, Singapore (SG); Fei Xie, Singapore (SG); Naiwei Xie, Singapore (SG)

(21) Appl. No.: 17/364,711

(22) Filed: Jun. 30, 2021

Related U.S. Application Data
(63) Continuation of application No. PCT/IB2021/055676, filed on Jun. 25, 2021.

(30) Foreign Application Priority Data
Jun. 23, 2021 (SG) 10202106886W

(51) Int. Cl. G07F 17/32

(52) U.S. Cl. CPC G07F 17/3241; G07F 17/3293; G07F 17/3239

(57) ABSTRACT

The embodiments of the present disclosure provide a method, apparatus and system for processing an abnormal event and a device and storage medium thereof. The method includes: in response to determining that an abnormal event occurs in a game region according to a first image of the game region, determining that a game played in the game region is in an abnormal state and outputting an abnormality promotion through a user interaction apparatus; in response to obtaining an abnormality recovery instruction, determining a current state of the game based on a second image of the game region, wherein the abnormality recovery instruction is in response to the abnormality promotion; in response to that the current state is a non-abnormal state, switching a detection logic for the game to be corresponding to the current state; controlling the game to continue by detecting an event and/or an object involved in the game region based on a third image of the game region obtained in the current state.

### CROSS REFERENCE TO RELATED APPLICATION

This application is a continuation application of International Application No. PCT/IB2021/055676 filed on Jun. 25, 2021, which claims priority to Singapore Patent Application No. 10202106886W, filed on Jun. 23, 2021, entitled “METHODS, APPARATUSES, SYSTEMS, DEVICES AND STORAGE MEDIA FOR PROCESSING ABNORMAL EVENT,” the disclosure of which is incorporated herein by reference in its entirety for all purposes.

### TECHNICAL FIELD

The present disclosure relates to the field of monitoring technologies, and in particular to a method, an apparatus, a system, a device and a storage medium for processing an abnormal event.

### BACKGROUND

More and more scenarios have intelligence requirements. Taking a game scenario as an example, during a game, it is usually required to supervise whether a player performs an operation such as violation or cheat, and calculate a score of each player based on the performance of each player during the game so as to determine a result of a game concerning win or lose. For example, in a card game, operations such as card dealing and card checking should follow game rules. Further, during the game, it is required to calculate a score according to cards of a player. In general, the above operations during the game are all operated manually. For example, the score is calculated manually based on the performance of each player in the game, and whether an abnormal event such as violation or cheat occurs in the game is supervised by person. Therefore, all these operations are tedious and lack intelligence. As a result, it is desired to provide some smarter solutions to realize automatic supervision and processing for an abnormal event in a game, thereby improving the experiences of users.

### SUMMARY

The present disclosure provides a method, apparatus and system for processing an abnormal event and a device and storage medium thereof.

According to a first aspect of the embodiments of the present disclosure, provided is a method for processing an abnormal event, including:

in response to determining that an abnormal event occurs in a game region according to a first image of the game region, determining that a game played in the game region is in an abnormal state and outputting an abnormality promotion through a user interaction apparatus;

in response to obtaining an abnormality recovery instruction, determining a current state of the game based on a second image of the game region, wherein the abnormality recovery instruction is in response to the abnormality promotion;

in response to that the current state is a non-abnormal state, switching a detection logic for the game to be corresponding to the current state;

controlling the game to continue by detecting an event and/or an object involved in the game region based on a third image of the game region obtained in the current state.

In some embodiments, the abnormality recovery instruction may be obtained in the following manners:

receiving the abnormality recovery instruction from the user interaction apparatus, wherein the abnormality recovery instruction is triggered by a specified control on the user interaction apparatus; or,

detecting the abnormality recovery instruction from a fourth image of the game region, wherein the fourth image is obtained in the abnormal state of the game.

In some embodiments, the abnormality recovery instruction is detected in response to detecting from the fourth image any one of:

a specified action performed by a particular user in a specified region;

a specified object placed in a specified region;

a specified object placed in a predetermined manner.

In some embodiments, determining the current state of the game based on the second image of the game region includes:

determining state information of one or more game props in the game region based on the second image;

determining the current state of the game based on the state information.

In some embodiments, the state information includes a number of the game props; determining the current state of the game based on the state information includes:

in response to that the number of the game props is 0, determining that the current state of the game is a pre-state of a game prop operation state;

in response to that the number of the game props is greater than 0 and smaller than a first threshold, determining that the current state of the game is the game prop operation state.

In some embodiments, the state information further includes an identifier of the game props and a placement mode of the game props, and determining the current state of the game based on the state information further includes:

in response to that the state information satisfies a first preset state condition, determining that the current state of the game is a game result processing state, wherein the first preset state condition includes the number of the game props reaching the first threshold, the placement mode of each game prop being identifier face visible, and the identifiers of the game props satisfying a condition for obtaining a game result;

in response to that the state information satisfies a second preset state condition, determining that the current state of the game is the game prop operation state, wherein the second preset state condition includes: the number of the game props reaching the first threshold and the placement mode of at least one game prop being identifier face invisible, or the number of the game props reaching the first threshold and the identifiers of the game props unsatisfying a condition for obtaining a game result.

In some embodiments, in response to determining that the current state of the game is the pre-state of the game prop operation state, switching a detection logic for the game to be corresponding to the current state, includes:

deleting a stored detection result of the game props, wherein the detection result includes position information of the game props and identifier information displayed on identifier faces of the game props.

In some embodiments, in response to determining that the current state of the game is the game prop operation state, switching a detection logic for the game to be corresponding to the current state, includes:

storing a detection result of the game props obtained based on the second image, wherein the detection result includes position information of the game props and identifier information displayed on identifier faces of the game props.

In some embodiments, the state information includes a placement position of the game props and a placement sequence of the game props, and the game region includes a first sub-region and a second sub-region for placing the game props; determining the current state of the game based on the state information includes:

in response to that any of the placement positions of the game props is outside of the first sub-region and the second sub-region, determining that the current state of the game is the abnormal state; or,

in response to that the placement sequence of placing the game props in the first sub-region and the second sub-region does not comply with a preset sequence, determining that the current state of the game is the abnormal state.

According to a second aspect of the embodiments of the present disclosure, provided is an apparatus for processing an abnormal event, including:

an abnormality promoting module, configured to in response to determining that an abnormal event occurs in a game region according to a first image of the game region, determine that a game played in the game region is in an abnormal state and outputting an abnormality promotion through a user interaction apparatus;

a game state determining module, configured to in response to obtaining an abnormality recovery instruction, determine a current state of the game based on a second image of the game region, wherein the abnormality recovery instruction is in response to the abnormality promotion;

a game state switching module, configured to in response to that the current state is a non-abnormal state, switch a detection logic for the game to be corresponding to the current state;

a detecting module, configured to control the game to continue by detecting an event and/or an object involved in the game region based on a third image of the game region obtained in the current state.

In some embodiments, the abnormality recovery instruction is obtained in the following manner:

receiving the abnormality recovery instruction from the user interaction apparatus, wherein the abnormality recovery instruction is triggered by a specified control on the user interaction apparatus; or,

detecting the abnormality recovery instruction from a fourth image of the game region, wherein the fourth image is obtained in the abnormal state of the game.

In some embodiments, the abnormality recovery instruction is detected in response to detecting from the fourth image any one of:

a specified action performed by a particular user in a specified region;

a specified object placed in a specified region;

a specified object placed in a predetermined manner.

In some embodiments, when used to determine the current state of the game based on the second image of the game region, the game state determining module is specifically configured to:

determine state information of one or more game props in the game region based on the second image;

determine the current state of the game based on the state information.

In some embodiments, the state information includes a number of game props;

when used to determine the current state of the game based on the state information, the game state determining module is specifically configured to:

in response to that the number of the game props is 0, determine that the current state of the game is a preset state of a game prop operation state;

in response to that the number of game props is greater than 0 and smaller than a first threshold, determine that the current state of the game is the game prop operation state.

In some embodiments, the state information further includes an identifier of the game prop and a placement mode of the game props; when used to determine the current state of the game based on the state information, the game state determining module is further configured to:

in response to that the state information satisfies a first preset state condition, determine that the current state of the game is a game result processing state, wherein the first preset state condition includes the number of the game props reaching the first threshold, the placement mode of each game prop being identifier face visible; and the identifiers of the game props satisfying a condition for obtaining a game result;

in response to that the state information satisfies a second preset state condition, determining that the current state of the game is the game prop operation state, wherein the second preset state condition includes the number of the game props reaching the first threshold and the placement mode of at least one game prop being identifier face invisible, or, the number of the game props reaching the first threshold and the identifiers of the game props unsatisfying a condition for obtaining a game result.

In some embodiments, the apparatus for processing an abnormal event further includes:

a deleting module, configured to delete a stored detection result of the game prop in response to determining that the current state of the game is the pre-state of the game prop operation state, wherein the detection result includes position information corresponding the game prop and identifier information displayed on the identifier face of the game prop.

In some embodiments, the apparatus for processing an abnormal event further includes:

a storing module, configured to, in response to determining that the current state of the game is the game prop operation state, store a detection result of the game props obtained based on the second image, wherein the detection result includes position information of the game props and identifier information displayed on identifier faces of the game props.

In some embodiments, the state information further includes a placement position of the game props and a placement sequence of the game props, and the game region includes a first sub-region and a second sub-region for placing the game props;

when used to determine the current state of the game based on the state information, the game state determining module is specifically configured to:

in response to that any of the placement positions of the game props is outside of the first sub-region and the second sub-region, determine that the current state of the game is the abnormal state; or,

in response to that the placement sequence of placing the game props in the first sub-region and the second sub-region does not comply with a preset sequence, determine that the current state of the game is the abnormal state.

According to a third aspect of the embodiments of the present disclosure, provided is an electronic device including a processor, a memory and computer programs stored in the memory for execution by the processor, where the computer programs are executed by the processor to implement the method according to the above first aspect.

According to a fourth aspect of the embodiments of the present disclosure, provided is a computer readable storage medium storing computer programs thereon, where the computer programs are executed to implement the method according to the above first aspect.

According to a fifth aspect of the embodiments of the present disclosure, provided is a system for processing an abnormal event, including a user interaction apparatus, a service system and an image collection apparatus.

The system includes the user interaction apparatus, the service system and the image collection apparatus.

The image collection apparatus is configured to collect an image of a game region and send the image to the service system.

The service system is configured to: determine that a game is in an abnormal state and transmit an abnormality promotion through the user interaction apparatus in response to determining that an abnormal event occurs in the game region based on a first image of the game region; in response to obtaining an abnormality recovery instruction, determine that the state of the game is a current state based on a second image of the game region, wherein the abnormality recovery instruction is sent in response to the abnormality promotion; in response to that the current state is a non-abnormal state, switch the game from the abnormal state to the current state; detect an event and/or object of the game region based on a third image of the game region obtained in the current state.

According to a sixth aspect of the embodiments of the present disclosure, provided is a computer program product including computer program(s) instructions, where when the computer program(s)/instructions are run in a processor, to implement the method according to the above first aspect.

In the embodiments of the present disclosure, in response to determining that an abnormal event occurs in a game region according to a first image of the game region collected by an image collection apparatus, a game played in the game region is determined to be in an abnormal state and an abnormality promotion is sent to a user through a user interaction apparatus of the game region; in response to receiving an abnormality recovery instruction sent by the user as responding to the abnormality promotion, a current state of the game is automatically determined based on a second image of the game region currently collected by the image collection apparatus; in response to that the current state is a non-abnormal state, the game is controlled to continue in a way that an object and/or event of the game is detected according to a third image of the game region collected in the current state and a detection logic in the current state. Compared with a mode in which the game is directly switched from a current state to a specified state according to a user instruction, the problems that a user switches a game to a wrong state due to mis-operation and a wrong detection logic is adopted to detect the game will be reduced effectively. Further, cheating operations that a user switches a game to a normal state without solving an abnormality will be reduced. In this way, the accuracy of the game processing result is improved, and poor experiences brought to users by frequent abnormality promotions resulting from wrong state switching will be avoided.

It should be understood that the above general descriptions and subsequent detailed descriptions are merely illustrative and explanatory and shall not be intended to limit the present disclosure.

### BRIEF DESCRIPTION OF THE DRAWINGS

The accompanying drawings, which are incorporated in and constitute a part of the present description, illustrate embodiments consistent with the present disclosure and serve to explain the principles of the present disclosure together with the description.

FIG. 1 is a schematic diagram of a game scenario according to one or more embodiments of the present disclosure.

FIG. 2 is a flowchart of a method of processing an abnormal event according to one or more embodiments of the present disclosure.

FIG. 3 is a schematic diagram of an application scenario according to one or more embodiments of the present disclosure.

FIG. 4 is a schematic diagram of a table game according to one or more embodiments of the present disclosure.

FIG. 5 is a schematic diagram of a logic structure of an apparatus for processing an abnormal event according to one or more embodiments of the present disclosure.

FIG. 6 is a schematic diagram of a logic structure of an electronic device according to one or more embodiments of the present disclosure.

### DETAILED DESCRIPTION OF THE EMBODIMENTS

Embodiments will be described in detail herein, with the illustrations thereof represented in the drawings. When the following descriptions involve the drawings, like numerals in different drawings refer to like or similar elements unless otherwise indicated. The embodiments described in the following embodiments do not represent all embodiments consistent with the present disclosure. Rather, they are merely embodiments of apparatuses and methods consistent with some aspects of the present disclosure as detailed in the appended claims.

The terms used in the present disclosure are for the purpose of describing a particular embodiment only, and not intended to be limiting of the present disclosure. The singular forms such as “a”, ‘said”, and “the” used in the present disclosure and the appended claims are also intended to include multiple, unless the context clearly indicates otherwise. It is also to be understood that the term “and/or” as used herein refers to any or all possible combinations that include one or more associated listed items. Further, the term “at least one” herein represents any one of multiple or any combination of at least two of multiple.

It is to be understood that although different information may be described using the terms such as first, second, third, etc. in the present disclosure, these information should not be limited to these terms. These terms are used only to distinguish the same type of information from each other. For example, the first information may also be referred to as the second information without departing from the scope of the present disclosure, and similarly, the second information may also be referred to as the first information. Depending on the context, the word “if” as used herein may be interpreted as “when” or “as” or “determining in response to”.

To help those skilled in the art to better understand the technical solutions of the embodiments of the present disclosure and make the above objects, advantages and features of the embodiments of the present disclosure clearer and more understandable, the technical solutions of the embodiments of the present disclosure will be further detailed below in combination with the accompanying drawings.

With the development of technology, more and more scenarios have higher requirements for intelligence. For example, states of some particular events may be monitored automatically by a device to output processing results based on detection logics in the states. In this way, tedious operations may be automatically performed in place of human, thereby improving user experiences. For example, in some game scenarios, it is required to supervise whether a player performs an operation such as violation and cheat, and calculate a score of each player according to the performance of each player in the game process, so as to determine a win or lose result of a game. However, if performed manually, these operations will be tedious and less intelligent. As a result, detection may be automatically performed for a game based on an image or video collected by an image collection apparatus in a game process to supervise any abnormal event in the game process. At the same time, a game processing result may also be automatically determined.

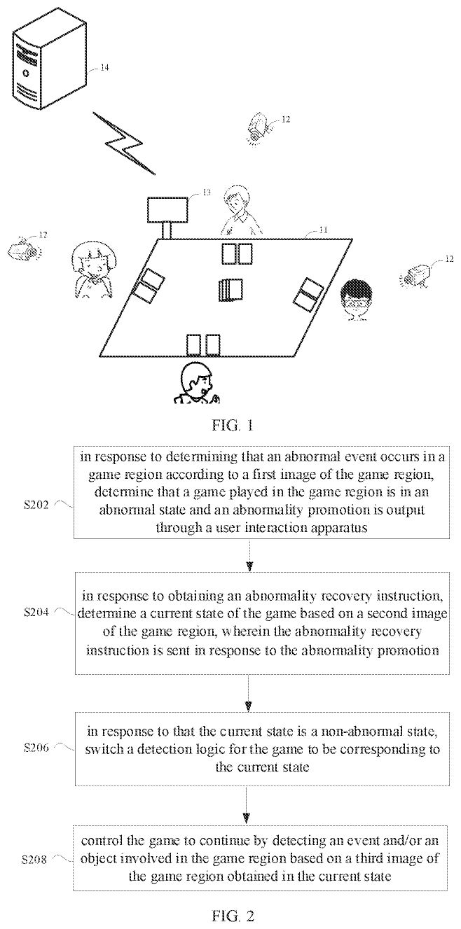

For example, as shown in FIG. 1, taking a card game as an example, the game may include several states such as a game ready state, a card dealing state, a card playing state, a score counting state and a game ending state and the like. In general, whether a violation operation occurs in each state of a game is supervised by players or supervisors, and the players calculate scores according to game rules to determine a winner at the end of the game. In order to improve the experiences of users, images of a game table and a given surrounding region may be collected by one or more cameras 12 disposed above the game table 11 and then sent to a service system 14 for detecting the game. The service system 14 may analyze out a current state of the game based on the images, for example, whether the game is in the card dealing state, the card playing state or the score counting state is analyzed according to the circumstances such as user operation, card number and points on the game table, and a detection logic in the state is executed. For example, if it is determined that the game is currently in the card dealing state according to the operations of users, whether a card dealing sequence complies with a preset rule or there is an error in the number of cards dealt or the like may be determined according to a preset detection logic. If the game is determined to be in the score counting state according to the operations of users and a state of the cards on the game table, a score of each player may be determined according to the collected images so as to determine a final winner. One user interaction apparatus 13 may be disposed on the game table 11 to communicably connect with the service system 14. A processing results of the service system 14 during different states of the game may be output to the user through an interaction interface of the user interaction apparatus 13. For example, in the card dealing state or the card playing state, if it is detected that the user deals or plays a card in violation of the game rules, an abnormality promotion may be sent through the interaction interface of the user interaction apparatus 13. Further, in the score counting state, the calculated scores of the players may be output through the interaction interface of the user interaction apparatus 13 so as to display the scores to the users.

In the above scenario where the service system performs identification and monitoring for a state of a game and executes a detection logic corresponding to the state, when detecting an abnormality by analyzing image analysis in each state of the game, the service system may switch the current state of the game to an abnormal state and stop detecting an event or object in the game in the abnormal state, avoiding finally outputting an inaccurate processing result. For example, in a process of monitoring a card game, if the service system 14 detects a game abnormality, the service system 14 may switch a state of the game to an abnormal state and send an abnormality promotion to a user through the user interaction apparatus 13. The service system 13 will no longer calculate the scores of the players. In this case, the user needs to switch a control on the user interaction apparatus 13 manually to recover the game to a normal state, thus recovering detection for the game. For example, the user may adjust a card dealing sequence to a correct sequence and then switch the current state of the game back to the card dealing state through the control on the user interaction apparatus 13 to continue the game. Alternatively, the user may also take back the cards on the game table and then switch the current state of the game back to a game ready state through the control on the user interaction apparatus 13 to restart the game. When the user touches the control on the user interaction apparatus 13 by hand to recover the state of the game to a normal state, a misoperation by the user may occur, which causes the state of the game to be mistakenly switched to a wrong state. For example, when desiring to switch the current state of the game to the card dealing state, the user may mistakenly switch the current state of the game to a card playing state or the user switches the state before solving an occurred abnormality. In a case of misoperation, due to a different detection logic corresponding to each state, the service system 14 may perform a detection according to a wrong detection logic, resulting in frequent abnormality events and abnormality warnings. If the user switches the state without solving an occurred abnormality, the accuracy of a game processing result cannot be guaranteed, and thus the user experiences will be severely affected.

Based on the above, the embodiments of the present disclosure provide a method of processing an abnormal event. The method of processing an abnormal event in the embodiments of the present disclosure may be performed by a service system which may be a server or a server cluster. In the service system, an event to be processed may be divided into several states in advance according to characteristics of the event and each state corresponds to one detection logic. In this way, various processes such as monitoring, abnormality detection, data analysis, processing result statistics may be performed for the event in this state.

The method of processing an abnormal event in the embodiments of the present disclosure may be applied to various events that occur in a specific region, for which a state is to be detected and a corresponding detection logic is to be performed based on the state. For example, the event may be a game event, an event that a user performs a task, and an event that a user operates some target objects and the like, which is not limited herein. Usually, the event may include several states. When the event is in different states, the service system may execute different detection logics to detect the event, thus ensuring the event proceeds in good order and obtaining an accurate processing result. For ease of explanation, the method of processing an abnormal event will be described below with a game scenario as an example in the embodiments of the present disclosure.

As shown in FIG. 2, the method may include the following steps.

At step S202, in response to determining that an abnormal event occurs in a game region according to a first image of the game region, it is determined that a game played in the game region is in an abnormal state and an abnormality promotion is output through a user interaction apparatus.

At step S204, in response to obtaining an abnormality recovery instruction, a current state of the game is determined based on a second image of the game region, wherein the abnormality recovery instruction is sent in response to the abnormality promotion.

At step S206, in response to that the current state is a non-abnormal state, a detection logic for the game is switched to be corresponding to the current state.

At step S208, the game is controlled to continue by detecting an event and/or an object involved in the game region based on a third image of the game region obtained in the current state.

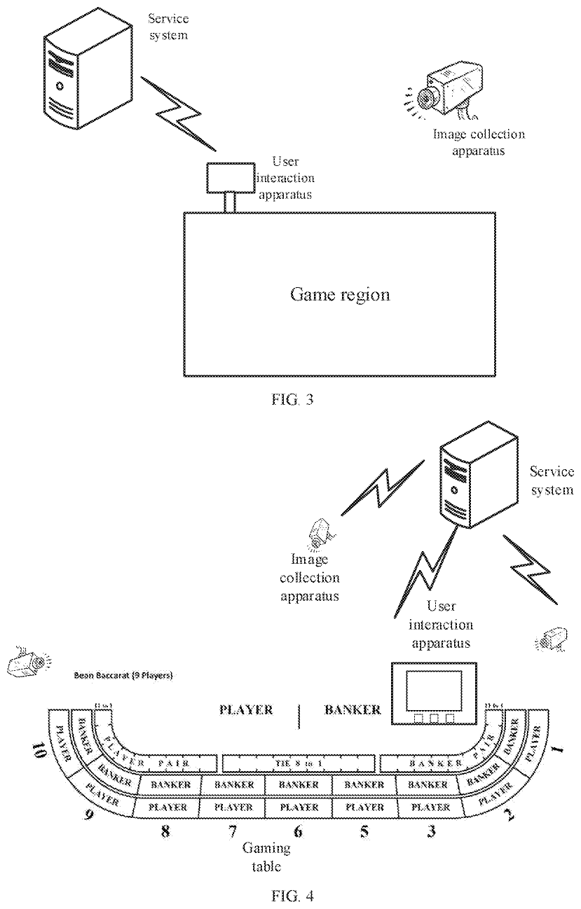

FIG. 3 shows a schematic diagram of an application scenario according to one or more embodiments of the present disclosure. One or more image collection apparatuses may be disposed above or around the game region to collect images or videos of the game region at different angles and send the images or videos to the service system in a wired or wireless manner. In this case, the service system may perform analysis and identification for gestures and actions of users, and states of target objects operated by the users in the images or videos to determine a current state of the game, and then perform corresponding processing according to a detection logic corresponding to the state. The target objects may be various game props in the game scenario, for example, card, chip, dice and game coin and the like. Taking a card game scenario as an example, if the game is in a card dealing state currently, whether there is any violation in the card dealing state may be determined according to the card dealing rules. If the game is currently in a score counting state, a score of each player may be calculated according to the score counting rules.

In the step 202, when detecting that an abnormal event (for example, an error of a sequence in which a user deals cards, a violation that a user plays a card and the like) occurs in the game region based on the first image of the game region collected by the image collection apparatus, the service system may determine the current state of the game to be in an abnormal state and switch the current state of the game to the abnormal state (for example, implemented by switching game state parameters), and then output an abnormality promotion through the user interaction apparatus. For example, the service system may output a voice promotion through the user interaction apparatus to promotion a user about occurrence of the abnormality, or output a text or image promotion through an interaction interface on the user interaction apparatus to promotion the user about occurrence of the abnormality. Of course, the voice promotion and the image promotion may be output at the same time. With the voice promotion or the image promotion, the user may find an abnormality occurred in a game process in time and perform corresponding processing so as to ensure the game proceeds orderly. After switching to the abnormal state, the service system will stop detecting the event or object in the game region and will no longer perform data analysis and result statistics and the like, for example, will no longer calculate the scores of the players and the like. The user interaction apparatus may be an apparatus having a display interface in the game region, for example, an apparatus having a display interface, which is fixed on a game table, or a handheld apparatus and the like, which is not limited in the embodiments of the present disclosure.

In the step 204, if a user (e.g. a card game player or a game supervisor) desires to continue the game after receiving an abnormality promotion, the user may send an abnormality recovery instruction to the service system. After receiving the abnormality recovery instruction sent by the user in response to the abnormality promotion, the service system may determine a current state of the game in the game region based on the second image of the game region collected currently by the image collection apparatus. Taking a card game as an example, after receiving an abnormality recovery instruction sent by the user in response to an abnormality promotion, the service system may obtain an image of a game table currently collected by the image collection apparatus and then analyze the image to determine a current state of the game, for example, if a card dealing state is switched to an abnormal state due to a wrong card dealing sequence, the user may send an abnormality recovery instruction after adjusting the card dealing sequence. At this time, the service system determines that the game is still in the card dealing state based on the image, and therefore the current state is the card dealing state. If the user takes back all cards and then sends the abnormality recovery instruction, the service system will determine the game is in a game ready state at this time since the service system does not detects any card on the game table based on the image. Thus, the current state is the game ready state.

In the step 206, if the current state is a non-abnormal state, the game may be switched from the abnormal state to the current state, a third image of the current state is collected and then the game is processed based on the third image and a detection logic corresponding to the current state, if the game is determined to be in a card dealing state at this time, if the game is switched from the abnormal state to the card dealing state, and then the detection logic of the card dealing state is invoked to process the game, for example, detect whether the card dealing sequence is correct and whether the number of cards of each user is correct and the like. If the game is determined to be in a card playing state at this time, the game is switched from the abnormal state to the card playing state, and then the detection logic of the card playing state is invoked to process the game, for example, detect whether a card playing rule is violated and calculate the score of each player after each card playing round and the like. If the game is determined to be in a score counting state at this time, a total score of each player is calculated based on the score of each player calculated after each card playing round so as to determine a final winner. Of course, if it is determined that the current state of the game is still an abnormal state according to the image of the current game region, for example, the user may not complete the processing of the current abnormality, or the game still does not comply with a rule after processing, the current state of the game is continued to be maintained in the abnormal state and an abnormality promotion is sent.

After receiving the abnormality recovery instruction sent by the user in response to the abnormality promotion, the service system automatically determines a current state of the game in the game region based on the image of the game region currently collected by the image collection apparatus and invokes a detection logic corresponding to the state to detect the game. Compared with a mode in which a game is directly switched to a specified state according to a user instruction, the problems that a user switches a game to a wrong state due to misoperation or a user switches the game to a normal state without solving an abnormality will be effectively reduced. In this way, the accuracy of the game processing result is improved, and poor experiences brought to users by frequent abnormality promotions resulting from wrong state switching will be avoided.

After receiving the abnormality promotion, the user may process an abnormality and then send an abnormality recovery instruction so as to recover the game from the abnormal state to the normal state and recover the game detection. In some implementations, in step 204, when obtaining the abnormality recovery instruction sent by the user in the game region in response to the abnormality promotion, the service system may receive the abnormality recovery instruction sent by the user from the user interaction apparatus in the game region. For example, a specified control may be disposed on an interaction interface of the user interaction apparatus, for example, a special control or button for abnormality recovery may be disposed. If the user desires to recover the game to the normal state after receiving the abnormal promotion, the user may trigger the specified control or button on the user interaction apparatus to send the abnormality recovery instruction. In some implementations, in order to facilitate operations of a user, the user in the game region may directly perform some promotion operations as the abnormality recovery instruction. The service system may identify the abnormality recovery instruction according to a fourth image of the game region collected by the image collection apparatus.

In some implementations, a specific user in the game region may perform a specific action or make a specific pose as trigger information of the abnormality recovery instruction. After identifying the specific user action or pose from the fourth image collected by the image collection apparatus, the service system may determine that the abnormality recovery instruction is obtained. For example, when desiring to recover an event from an abnormal state to a normal state, the specific user in the game region may make a V-shaped gesture. After identifying the V-shaped gesture of the specific user from the collected fourth image of the game region, the service system may perform analysis of the current state of the game and state switching operation. The specific user may be a user located in a specified position in the game region, for example, may be a game supervisor or a specific role in the game process.

In some implementations, a user in the game region may place a specified object in a specified region in the game region as trigger information of the abnormality recovery instruction. After identifying that the specified object is placed in the specified region from the fourth image collected by the image collection apparatus, the service system determines that the abnormality recovery instruction is obtained. The specified region may also be a region marked in advance in the game region, and the specified object may also be an object that is pre-placed and distinguishable from other objects in the scenario, which can be se according to actual situations. Taking a card game as an example, a region may be marked in advance on a game table. When the user desires to recover the game from an abnormal state to a normal state, the user may place one card in the region. After identifying that one card is placed in the marked region from the fourth image collected by the image collection apparatus, the service system determines that the abnormality recovery instruction is obtained and performs a subsequent detection logic.

In some implementations, a user in the game region may place the specified object in the game region in a preset manner as the trigger information of the abnormality recovery instruction. After identifying that the specified object is placed in a preset manner from the fourth image collected by the image collection apparatus, the service system determines that the abnormality recovery instruction is obtained. The specified object may be dice. When the user desires to switch the game from an abnormal state to a normal state, a six-point face of the dice may be placed upward. After identifying that the six-point face of the dice is placed upward from the fourth image collected by the image collection apparatus, the service system determines that the abnormality recovery instruction is obtained. In an actual application, the user may trigger the abnormality recovery instruction in various manners. The abnormality recovery instruction can be sent by simply making a gesture or performing an action or placing an object, thereby facilitating the user operations and improving the user experiences.

In the step S204, in some implementations, when a current state of the game is determined based on the second image of the game region, the current state of the game may be determined based on state information on a game prop in the game region. The game prop may be various props used in the game process, for example, may be a card, a chip, a dice, a game coin and the like involved in the game. In some game scenarios, the entire game process mainly include some operations performed by a user for the game prop. For example, in a card game, the user may use game coins to add points, deal cards, flop cards, and play cards and the like. The current state of the game prop usually reflects the current state of the game. For example, the state of the card may reflect which stage the game proceeds to. Generally, the game may include a pre-state of the game prop operation state, a game prop operation state, and a game result processing state and the like. In a case of the pre-state of the game prop operation state, the user may predict a game result, for example, the user may predict a win or lose result of each player in the game, and use the game coins to add points. In a case of the game prop operation state, the user may operate the game prop, for example, may deal or flop cards. In a case of the game result processing state, the user may determine a game result based on the circumstances of the game prop in the game region. For example, the user may determine a win or lose result of the game or the like by calculating a score of each player in the game region according to the circumstances of the cards. Therefore, the state information of the game prop may be identified from the second image and the current state of the game may be determined based on the stale information on the game prop.

In some embodiments, the state information on the game prop may be one or more of a number of game props, an identifier of a game prop, a placement position of a game prop, a placement mode of a game prop, and a placement sequence of a plurality of game props. For example, in a card game, a state of the game may be determined by determining whether the game is started and whether card dealing is completed based on the number of cards, or the current state of the game may be determined based on the identifier information on the cards, for example, the current state of the game may be determined according to identifier information such as whether an identifier face of the card is visible, and a digit and suit displayed on the identifier face of the card, or the current state of the game may be determined according to information such as placement position of card, for example, on which region of the game table the card is placed, or a manner in which the cards are placed, or the cards are stacked in order or placed in disorder, or a sequence in which the cards are placed. For example, in some card games, a plurality of regions may be marked in advance in the game table and each region has a specific meaning. In a game process, the cards or chips or the like corresponding to a specific type should be placed in a corresponding marked region in a specific manner to satisfy the game rules. If according to the image collected by the image collection apparatus, it is identified that the cards of corresponding type are not placed in the marked region, or the cards are not placed as per a rule in the marked region, for example, the cards are not placed with front sides facing upward but with reverse sides facing upward, or the cards are not placed as per a preset sequence in the marked region, it is determined that an abnormality occurs.

In some embodiments, the state information may be the number of game props. When the current state of the game is determined based on the state information, the number of the game props in the game region may be determined based on the second image of the game region collected by the image collection apparatus. In response to that the number of the game props is 0, it is determined that the state of game is a pre-state of the game prop operation state. In response to that the number of the game props is greater than 0 and smaller than a first threshold, it is determined that the current state of the game is the game prop operation state.

In some embodiments, the state information on the game prop may further include an identifier of the game prop and a placement mode of the game prop. When the current state of the game is determined based on the state information of the game prop, the number of the game props, the placement mode of the game props, the identifier faces of the game props and the like may be firstly identified from the second image of the game region and then the current state of the game may be determined based on the above information. For example, in response to that the state information satisfies a first preset state condition, it is determined that the current state of the game is a game result processing state, where the first preset state condition includes the number of game props reaching the first threshold, the placement mode of each game prop being visible on identifier face, and the identifier of each game prop satisfying a condition for obtaining a game result.

In some embodiments, in response to that the state information satisfies a second preset state condition, it is determined that the current stale of the game is the game prop operation state, where the second preset state condition includes that the number of the game props reaching the first threshold and the placement mode of at least one game prop being invisible on identifier face, or the number of the game props reaching the first threshold and the identifier of each game prop unsatisfying a condition for obtaining a game result.

Taking a card game as an example, in some card games, the number of cards dealt to each player in each round of game is within a fixed number range, for example, two to three cards are dealt to each player, and whether the third card is dealt may be determined according to the suits and points of the first two cards. Therefore, the current number of cards of each player on the game table may be determined according to the second image of the game region collected by the image collection apparatus. If there are no cards on the game table, it indicates that no cards are dealt at this time, that is, the game is in the pre-state of the card dealing state. In this state, the user may predict the game result and add points. If the number of cards of each player on the game table is greater than 0 but smaller than 2, it indicates that the game is in a card dealing state. If each player has two cards and the placement mode of the cards is that the identifier face displaying the suit, point and the like of the cards is invisible, or a game result cannot be determined based on the identifier information on the cards, it is determined that the game is still in the card dealing state at this time. Of course, if each player has two cards and the placement mode of the cards is that the identifier face is visible, a game result may be also determined based on the identifier information of the cards. In this case, it is determined that the game is in a game result processing state. In this state, the game result may be determined according to the identified identifier information of the cards.

Generally, the information on each game prop in the game region, for example, the position of the game prop and the identifier information displayed on the identifier face of the game prop, may be determined according to the image collected by the image collection apparatus. Upon every operation of the game prop, the user may cache the information on the game prop so that the game result can be determined based on the cached information on the game prop at the end of the game. In a case of an abnormality promotion resulting from any abnormality occurring to a game process, the user may correct the abnormality in the following manners: in the first manner, the game region is recovered to the game ready state to restart a new round of game, and in the second manner, a wrong operation is corrected to continue the original game.

In some embodiments, if it is determined that the current state of the game is the pre-state of the game prop operation state based on the second image of the game region in response to receiving an abnormality recovery instruction, it indicates that the user adopts the manner of restarting a new round of game when solving the abnormality. Therefore, a stored detection result of the game prop may be cleared, where the detection result includes the position information of the game prop and the identifier information displayed on the identifier face of the game prop. In this way, the impact of the stored detection result on the restarted new round of game is avoided.

In some embodiments, if it is determined that the current state of the game is the game prop operation state in response to receiving the abnormality recovery instruction, it indicates that the user adopts the manner of correcting errors to continue the original game. Thus, the game is still in the game prop operation state at this time. The identification of the position information and the identifier information of the game prop in the second image can be continued and the position information and the identifier information are stored so that the game result may be determined based on the above stored information in the game prop operation state.

In some embodiments, the state information of the game prop further includes a placement position of a game prop and a placement sequence of a plurality of game props. The game region may include a first sub-region and a second sub-region for placing game props. When the current state of the game is determined based on the state information, the placement positions and the placement sequence of various game props in the game region may be firstly determined and then the current state of the game is determined based on the above information. For example, in response to that any of the placement positions of the game props is located outside the first sub-region and the second sub-region, it is determined that the current state of the game is an abnormal state. Alternatively, in response to that the plurality of game props are not placed in the first sub-region and the second sub-region in a preset sequence, it is determined that the current state of the game is an abnormal state. By monitoring the operations of the user for the game prop, an abnormal operation can be detected in time and a promotion is made. Thus, it is ensured that the operations of the user for the game prop comply with the game rules, thereby ensuring the fairness and accuracy of the game result.

The method of processing an abnormal event according to the embodiments of the present disclosure will be further explained below in combination with one specific embodiment.

Computer vision technology has already been widely applied to smart gaming places. Images of a gaming place or gaming table are collected by a camera and then an on-going game on the gaming table is monitored and analyzed based on the images so as to automatically identify any non-compliant action on the gaming table and automatically calculate a payout result of each round of game. In this way, the actions on the gaming table will be more compliant and the gaming game will be smarter and thus the game result will be fairer and more reliable.

Baccarat game is a common card game in gaming places. The Baccarat game involves a banker, a player, a tie and a pair. A player may choose to add points on any one of the banker, the player, the tie and the pair according to his own idea. After the player adds points, a dealer will draw 4-6 cards from 3-8 packs of shuffled cards and a sum of two cards of the player and the banker are calculated respectively, so as to determine which sum is more close to 9, or determine whether the banker or the player has a pair or whether the sums of the cards are equal, and then the payout result of each player can be calculated according to the points of the cards and how much points the player adds.

FIG. 4 shows a schematic diagram of a Baccarat game in a gaming place, in which one camera is disposed above and at both sides of a gaming table respectively to monitor circumstances occurring to the gaming table. Image data collected by the cameras will be sent to a service system of the gaming place. The service system may analyze a current state of the game based on the images, and perform a detection logic in the corresponding state. In the service system, the Baccarat game is divided into five states, i.e. idle, adding points, dealing, payout, and halt. In different states of the game, the service system will invoke different detection logics to detect the game process. A user interaction apparatus is also disposed near the gaming table, so that a user may interact with the service system through the user interaction apparatus, for example, switch a state of the game. In response to monitoring an abnormality of the game, the service system will also send a warning through the user interaction apparatus.

After the user switches the current state of the game from the idle state to the adding points state (i.e. triggering the game to start) through the user interaction apparatus on the gaming table, the service system will determine a current state of the game based on the images collected by the cameras to automatically complete the state switching and perform the detection logic in the corresponding state. In each state, the player or the dealer must operate in compliance with a game rule. When the service system detects that an abnormal event occurs to the operation of the player or dealer by analyzing the images, for example, if the dealer deals cards in non compliance with the game rule in the gaming state, the service system will switch the game to the halt state and send warning information through the user interaction apparatus. After the game enters the halt state, the service system will resume normal operation, that is, will not calculate the win or lose result of each player in each round of game.

In the prior art, if it is desired that the game proceeds into normal state, the dealer may switch the game to a particular state, for example, the idle state, through a state switching button on the user interaction apparatus and then the game is restarted. However, in this manner, there may be misoperation of the dealer which causes wrong state switching, and the service system will process the current state according to the wrong detection logic, or the dealer may switch the state to a normal state without correcting the error, affecting the fairness of the game.

In order to avoid the problem, the dealer or the player may firstly correct the abnormality after finding the warning information (at this time, the system is in the halt state). For example, if the game enters the halt state due to a wrong card dealing sequence of the dealer, the dealer may clear the gaming table (starting the next round of game by discarding the current round), or re-sort the cards on the gaming table in a correct sequence (continuing that game). After handling the abnormality, the dealer or the player may click a resume button on the user interaction apparatus to trigger an abnormality recovery instruction, or the dealer or the player may perform a specific action or place a specified object in a predetermined region of the gaming table to trigger the abnormality recovery instruction. After receiving the abnormality recovery instruction from the user interaction apparatus, or identifying the specific action or gesture made by the dealer or the player from the images collected by the cameras, or identifying that the specified object is placed in the predetermined region, the service system determines that the abnormality recovery instruction is received. At this time, the service system will analyze the current state of the game based on the current images of the gaming table collected by the cameras. In response to determining that no abnormality currently occurs to the game, the service system switches the game to the current state. For example, the service system will identify the cards on the gaming table and markers (marker used to mark which player adds points and how much points is added) based on the images of the gaming table currently collected by the cameras, and comprehensively determine that the state should be switched to adding points state, gaming state, payout state or should continue staying in the halt state based on information such as the number, position, suit and point of the cards, and the type and position of the markers and the like, which is detailed below.

If it is identified that the cards on the gaming table are not placed in the marked region of the gaming table based on the images, or the cards are placed in a wrong way, for example, four cards are in a player zone, and two cards are in a banker zone, it is determined that the game is still in an abnormal state currently and will continue to stay in the halt state. If it is identified that the cards on the gaming table are placed correctly based on the images, i.e. there is no abnormality, the state switching may be performed in the following manner.

(1) When it is determined based on the images collected by the cameras that there is no card on the gaming table currently, the game is switched to the adding points state, a cache is reset and the previously-stored information on the cards and chips on the gaming table are cleared.

(2) When it is determined based on the images collected by the cameras that there are 1-3 cards on the gaming table, the information on the cards on the gaming table is identified and stored to the cache, and at the same time, chip-related information of current frame on the gaming table is identified and stored, and the game is switched from the halt state to the gaming state.

(3) If it is determined based on the images collected by the cameras that there are 4-6 cards on the gaming table, two cases are considered here. If the current cards are placed with front sides facing upward and a result can be obtained, the game is switched to the payout state, and the result and the chip information of the current frame are notified to other service functional modules. If the result cannot be obtained or the cards are not all placed with front sides facing upward, the data of cards and chip information of the current frame are stored to the cache and the state is switched to the gaming state.

In this manner, when the user recovers the state in the service system from the abnormal state, the user may send a trigger instruction. The service system will determine whether an abnormality is eliminated according to the current images of the gaming table, and then determine the current state of the game according to the cards or markers on the gaining table after the abnormality is eliminated, and switch the game to the state. In this way, the unfairness of the game result resulting from switching to a wrong state due to a misoperation of the user, or frequent occurrence of abnormalities and warnings of the service system due to an invoked detection logic unmatched with the current state is avoided, thereby improving the fairness and accuracy of the game result on the gaming table.

Correspondingly, the embodiments of the present disclosure further provide an apparatus for processing an abnormal event. As shown in FIG. 5, the apparatus 50 includes the following modules.

an abnormality promoting module 51, configured to in response to determining that an abnormal event occurs in a game region according to a first image of the game region, determine that a game played in the game region is in an abnormal state and outputting an abnormality promotion through a user interaction apparatus;

a game state determining module 52, configured to in response to obtaining an abnormality recovery instruction, determine a current state of the game based on a second image of the game region, wherein the abnormality recovery instruction is in response to the abnormality promotion;

a game state switching module 53, configured to in response to that the current state is a non-abnormal state, switch a detection logic for the game to be corresponding to the current state;

a detecting module 54, configured to control the game to continue by detecting an event and/or an object involved in the game region based on a third image of the game region obtained in the current state.

In some embodiments, the abnormality recovery instruction may be obtained in the following manner:

receiving the abnormality recovery instruction from the user interaction apparatus, wherein the abnormality recovery instruction is triggered by a specified control on the user interaction apparatus; or,

detecting the abnormality recovery instruction from a fourth image of the game region, wherein the fourth image is obtained in the abnormal state of the game.

In some embodiments, the abnormality recovery instruction is detected in response to detecting from the fourth image any one of:

a specified action performed by a particular user in a specified region;

a specified object placed in a specified region;

a specified object placed in a predetermined manner.

In some embodiments, when used to determine the current state of the game based on the second image of the game region, the game state determining module is specifically configured to:

determine state information of one or more game props in the game region based on the second image;

determine the current state of the game based on the state information.

In some embodiments, the state information includes a number of the game props;

when used to determine the current state of the game based on the state information, the game state determining module is specifically configured to:

in response to that the number of game props is 0, determine that the current state of the game is a pre-state of a game prop operation state;

in response to that the number of game props is greater than 0 and smaller than a first threshold, determine that the current state of the game is the game prop operation state.

In some embodiments, the state information further includes an identifier of the game prop and a placement mode of the game props; when used to determine the current state of the game based on the state information, the game state determining module is further configured to:

in response to that the state information satisfies a first preset state condition, determine that the current state of the game is a game result processing state, wherein the first preset state condition includes the number of the game props reaching the first threshold, the placement mode of each game prop being identifier face visible, and the identifiers of the game props satisfying a condition for obtaining a game result;

in response to that the state information satisfies a second preset state condition, determining that the current state of the game is the game prop operation state, wherein the second preset state condition includes the number of the game props reaching the first threshold and the placement mode of at least one game prop being identifier face invisible, or, the number of the game props reaching the first threshold and the identifiers of the game props unsatisfying a condition for obtaining a game result.

In some embodiments, the apparatus for processing an abnormal event further includes:

a deleting module, configured to delete a stored detection result of the game prop in response to determining that the current state of the game is the pre-state of the game prop operation state, wherein the detection result includes position information corresponding the game prop and identifier information displayed on the identifier face of the game prop.

In some embodiments, the apparatus for processing an abnormal event further includes:

a storing module, configured to, in response to determining that the current state of the game is the game prop operation state, store a detection result of the game props obtained based on the second image, wherein the detection result includes position information of the game props and identifier information displayed on identifier faces of the game props.

In some embodiments, the state information includes a placement position of the game props and a placement sequence of the game props, and the game region includes a first sub-region and a second sub-region for placing the game props; determining the current state of the game based on the state information includes:

when used to determine the current state of the game based on the state information, the game state determining module is specifically configured to:

in response to that any of the placement positions of the game props is outside of the first sub-region and the second sub-region, determining that the current state of the game is the abnormal state; or,

in response to that the placement sequence of placing the game props in the first sub-region and the second sub-region does not comply with a preset sequence, determining that the current state of the game is the abnormal state.

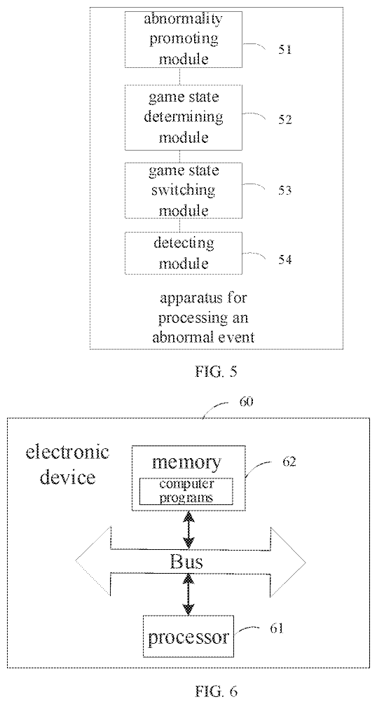

Further, the embodiments of the present disclosure further provide an electronic device 60. As shown in FIG. 6, the electronic device 60 includes a processor 61, a memory 62, and computer programs stored in the memory 62 for execution by the processor 61. The computer programs are executed by the processor 61 to implement the method according to any one of the above embodiments.

Correspondingly, the embodiments of the present disclosure further provide a system for processing an abnormal event. The system includes a user interaction apparatus, a service system and an image collection apparatus.

The image collection apparatus is configured to collect an image of a game region and send the image to the service system.

The service system is configured to: in response to determining that an abnormal event occurs in a game region according to a first image of the game region, determine that a game played in the game region is in an abnormal state and outputting an abnormality promotion through a user interaction apparatus; in response to obtaining an abnormality recovery instruction, determine a current state of the game based on a second image of the game region, wherein the abnormality recovery instruction is in response to the abnormality promotion; in response to that the current state is a non-abnormal state, switch a detection logic for the game to be corresponding to the current state; control the game to continue by detecting an event and/or an object involved in the game region based on a third image of the game region obtained in the current state.

The embodiments of the present disclosure further provide a computer readable storage medium storing computer programs thereon. The computer programs are executed by a processor to implement the method according to any one above embodiment.

The embodiments of the present disclosure also provides a computer program product including computer program(s)/instructions, where when the computer program(s)/instructions are run in a processor, the method described according to any one above embodiment is implemented.

The computer readable medium includes permanent, non-permanent, mobile and non-mobile media, which can realize information storage by any method or technology. The information may be computer readable instructions, data structures, program modules and other data. The embodiments of the computer storage medium include but not limited to: a phase change random access memory (PRAM), a Static Random Access Memory (SRAM), a Dynamic Random Access Memory (DRAM), and other types of RAMs, Read-Only Memory (ROM), an Electrically-Erasable Programmable Read-Only Memory (EEPROM), a Flash Memory, or other memory technology, CD-ROM, digital versatile disc (DVD) or other optical storage, cassette type magnetic tape, magnetic disk storage, or other magnetic storage device or other non-transmission medium for storing information accessible by computing devices. According to the definition of the specification, the computer readable medium does not include transitory computer readable media, for example, modulated data signal and carriers.

It may be known from descriptions of the above embodiments that persons skilled in the art may clearly understand that the embodiments of the present disclosure may be implemented by means of software and a necessary general hardware platform. Based on such understanding, the technical solutions of embodiments of the present disclosure essentially or a part contributing to the prior art may be embodied in the form of a software product, and the computer software product may be stored in a storage medium, such as a ROM/RAM, a diskette or a compact disk, and includes several instructions for enabling a computer device (such as a personal computer, a server or a network device) to perform the methods of different embodiments or some parts of the embodiments of the present disclosure.

The systems, methods, modules or units described in the above embodiments may be specifically implemented by a computer chip or an entity, or may be implemented by a product with a particular function. A typical implementing device may be a computer, and the computer may specifically be a personal computer, a laptop computer, a cellular phone, a camera phone, a smart phone, a personal digital assistant, a media player, a navigation device, an email transceiver, a game console, a tablet computer, a wearable device, or a combination of any several devices of the above devices.

The embodiments in the present disclosure are described in a progressive manner, each embodiment focuses on differences from other embodiments, and same or similar parts among the embodiments may be referred to each other. Especially, since apparatus embodiments are basically similar to method embodiments, simple descriptions are made to the apparatus embodiments, and relevant parts may be referred to part of the descriptions of the method embodiments. The apparatus embodiments described above are merely illustrative, where modules described as separate members may be or not be physically separated, and functions of different modules may be implemented in the same or several software and/or hardware during implementation of the embodiments of the present disclosure. Part or all of the modules may also be selected according to actual requirements to achieve the objectives of the solution of the embodiment. Persons of ordinary skill in the art may understand and implement the solutions without creative work.

The above descriptions are merely specific embodiments of the present disclosure. It is to be noted that persons of ordinary skill in the art may also make several improvements and modifications without departing from the principles of the embodiments of the present disclosure, and these improvements and modifications shall also be included in the scope of protection of embodiments of the present disclosure

1. A method of processing an abnormal event, comprising:
in response to determining that an abnormal event occurs in a game region according to a first image of the game region, determining that a game played in the game region is in an abnormal stale and outputting an abnormality promotion through a user interaction apparatus;
in response to obtaining an abnormality recovery instruction, determining a current state of the game based on a second image of the game region, wherein the abnormality recovery instruction is in response to the abnormality promotion;
in response to that the current state is a non-abnormal state, switching a detection logic for the game to be corresponding to the current state;
controlling the game to continue by detecting an event and/or an object involved in the game region based on a third image of the game region obtained in the current state.

2. The method according to claim 1, further comprises obtaining the abnormality recovery instruction by at least one of:
receiving the abnormality recovery instruction from the user interaction apparatus, wherein the abnormality recovery instruction is triggered by a specified control on the user interaction apparatus; and,
detecting the abnormality recovery instruction from a fourth image of the game region, wherein the fourth image is obtained in the abnormal state of the game.

3. The method according to claim 2, wherein the abnormality recovery instruction is detected in response to detecting from the fourth image any one of:
a specified action performed by a particular user in a specified region;
a specified object placed in a specified region;
a specified object placed in a predetermined manner.

4. The method according to claim 1, wherein determining the current state of the game based on the second image of the game region comprises:
determining state information of one or more game props in the game region based on the second image;
determining the current state of the game based on the state information.

5. The method according to claim 4, wherein the state information comprises a number of game props, determining the current state of the game based on the state information comprises:
in response to that the number of the game props is 0, determining that the current state of the game is a pre-state of a game prop operation state;
in response to that the number of the game props is greater than 0 and smaller than a first threshold, determining that the current state of the game is the game prop operation state.

6. The method according to claim 5, wherein the state information further comprises an identifier of the game props and a placement mode of the game props, and determining the current state of the game based on the state information further comprises:
in response to that the state information satisfies a first preset state condition, determining that the current state of the game is a game result processing state, wherein the first preset state condition comprises the number of the game props reaching the first threshold, the placement mode of each game prop being identifier face visible, and the identifiers of the game props satisfying a condition for obtaining a game result;
in response to that the state information satisfies a second preset state condition, determining that the current state of the game is the game prop operation state, wherein the second preset state condition comprises:
the number of the game props reaching the first threshold and the placement mode of at east one game prop being identifier face invisible, or
the number of the game props reaching the first threshold and the identifiers of the game props unsatisfying a condition for obtaining a game result.

7. The method according to claim 5, wherein, in response to determining that the current state of the game is the pre-state of the game prop operation state, switching a detection logic for the game to be corresponding to the current state, comprises:
deleting a stored detection result of the game props, wherein the detection result comprises position information of the game props and identifier information displayed on identifier faces of the game props.

8. The method according to claim 5, wherein, in response to determining that the current state of the game is the game prop operation state, switching a detection logic for the game to be corresponding to the current state, comprises:
storing a detection result of the game props obtained based on the second image, wherein the detection result comprises position information of the game props and identifier information displayed on identifier faces of the game props.

9. The method according to claim 4, wherein the state information comprises a placement position of the game props and a placement sequence of the game props, and the game region comprises a first sub-region and a second sub-region for placing the game props; determining the current state of the game based on the state information comprises:
in response to that any of the placement positions of the game props is outside of the first sub-region and the second sub-region, determining that the current state of the game is the abnormal state; or,
in response to that the placement sequence of placing the game props in the first sub-region and the second sub-region does not comply with a preset sequence, determining that the current state of the game is the abnormal state.

10. An electronic device, comprising:
a processor,
a memory, and
computer programs stored in the memory for execution by the processor, wherein the computer programs are executed by the processor to implement a method of processing an abnormal event, the method comprising:
in response to determining that an abnormal event occurs in a game region according to a first image of the game region, determining that a game played in the game region is in an abnormal state and outputting an abnormality promotion through a user interaction apparatus;
in response to obtaining an abnormality recovery instruction, determining a current state of the game based on a second image of the game region, wherein the abnormality recovery instruction is in response to the abnormality promotion;
in response to that the current state is a non-abnormal state, switching a detection logic for the game to be corresponding to the current state;
controlling the game to continue by detecting an event and/or an object involved in the game region based on a third image of the game region obtained in the current state.

11. The electronic device according to claim 10, the method further comprises obtaining the abnormality recovery instruction by at least one of:
receiving the abnormality recovery instruction from the user interaction apparatus, wherein the abnormality recovery instruction is triggered by a specified control on the user interaction apparatus; and,
detecting the abnormality recovery instruction from a fourth image of the game region, wherein the fourth image is obtained in the abnormal state of the game.

12. The electronic device according to claim 11, wherein the abnormality recovery instruction is detected in response to detecting from the fourth image any one of:
a specified action performed by a particular user in a specified region;
a specified object placed in a specified region;
a specified object placed in a predetermined manner.

13. The electronic device according to claim 10, wherein determining the current state of the game based on the second image of the game region comprises:
determining state information of one or more game props in the game region based on the second image;
determining the current state of the game based on the state information.

14. The electronic device according to claim 13, wherein the state information comprises a number of game props, determining the current state of the game based on the state information comprises:
in response to that the number of the game props is 0, determining that the current state of the game is a pre-state of a game prop operation state;
in response to that the number of the game props is greater than 0 and smaller than a first threshold, determining that the current state of the game is the game prop operation state.

15. The electronic device according to claim 14, wherein the state information further comprises an identifier of the game props and a placement mode of the game props, and determining the current state of the game based on the state information further comprises:
in response to that the state information satisfies a first preset state condition, determining that the current state of the game is a game result processing state, wherein the first preset state condition comprises the number of the game props reaching the first threshold, the placement mode of each game prop being identifier face visible, and the identifiers of the game props satisfying a condition for obtaining a game result;
in response to that the state information satisfies a second preset state condition, determining that the current state of the game is the game prop operation state, wherein the second preset state condition comprises:
the number of the game props reaching the first threshold and the placement mode of at least one game prop being identifier face invisible, or
the number of the game props reaching the first threshold and the identifiers of the game props unsatisfying a condition fir obtaining a game result.

16. The electronic device according to claim 14, wherein, in response to determining that the current state of the game is the pre-state of the game prop operation state, switching a detection logic for the game to be corresponding to the current state, comprises:
deleting a stored detection result of the game props, wherein the detection result comprises position information of the game props and identifier information displayed on identifier faces of the game props.

17. The electronic device according to claim 14, wherein, in response to determining that the current state of the game is the game prop operation state, switching a detection logic for the game to be corresponding to the current state, comprises:
storing a detection result of the game props obtained based on the second image, wherein the detection result comprises position information of the game props and identifier information displayed on identifier faces of the game props.

18. The electronic device according to claim 13, wherein the state information comprises a placement position of the game props and a placement sequence of the game props, and the game region comprises a first sub-region and a second sub-region for placing the game props; determining the current state of the game based on the state information comprises:
in response to that any of the placement positions of the game props is outside of the first sub-region and the second sub-region, determining that the current state of the game is the abnormal state; or,
in response to that the placement sequence of placing the game props in the first sub-region and the second sub-region does not comply with a preset sequence, determining that the current state of the game is the abnormal state.

19. A computer readable storage medium, storing computer programs thereon, wherein the computer programs are executed by a processor to implement a method of processing an abnormal event, the method comprising:
in response to determining that an abnormal event occurs in a game region according to a first image of the game region, determining that a game played in the game region is in an abnormal state and outputting an abnormality promotion through a user interaction apparatus;
in response to obtaining an abnormality recovery instruction, determining a current state of the game based on a second image of the game region, wherein the abnormality recovery instruction is in response to the abnormality promotion;
in response to that the current state is a non-abnormal state, switching a detection logic for the game to be corresponding to the current state;
controlling the game to continue by detecting an event and/or an object involved in the game region based on a third image of the game region obtained in the current state.
